(19) United States
(12) Patent Application Publication
(10) Pub. No.: US 2026/0187086 A1
(43) Pub. Date: Jul. 2, 2026

(54) INFORMATION PROCESSING APPARATUS, METHOD, AND STORAGE MEDIUM

(71) Applicant: NEC Corporation, Tokyo (JP)

(72) Inventor: Kensuke WAGATA, Tokyo (JP)

(73) Assignee: NEC Corporation, Tokyo (JP)

(21) Appl. No.: 19/407,363

(22) Filed: Dec. 3, 2025

(30) Foreign Application Priority Data
Dec. 27, 2024 (JP) 2024-232260

(51) Int. Cl. G06F 16/2458; G06F 18/22; G06F 123/02

(52) U.S. Cl. CPC G06F 16/2477; G06F 18/22; G06F 2123/02

(57) ABSTRACT

The information processing apparatus 1X includes an acquisition means 21X and an identification means 24X. The acquisition means 21X is configured to acquire a query that is data representing a set of motions per time step and a template to be compared with the query. The identification means 24X is configured to repeatedly execute, in a case of identifying an association relationship between time steps of the query and time steps of the template, processing including: extracting unassociated time step(s) of the query and unassociated time step(s) of the template; and associating with each other a time step of the query and a time step of the template having the highest similarity between the extracted time step(s) of the query and the extracted time step(s) of the template. It can support user's decision making.

### INCORPORATION BY REFERENCE

This application is based upon and claims the benefit of priority from Japanese Patent Application No. 2024-232260, filed on Dec. 27, 2024, the disclosure of which is incorporated herein in its entirety by reference.

### TECHNICAL FIELD

The present disclosure relates to a technical field of an information processing apparatus, a method, and a storage medium related to processing of data representing a set of motions per time step.

There is a technique for analyzing time-series motion data. For example, Patent Literature 1 discloses a technique for augmenting motion data using several pieces of motion data.

### Patent Literature 1: JP 2024-117861 A

### SUMMARY

Upon generating pseudo data of time-series data representing motions by data augmentation, several pieces of time-series data used for the data augmentation need to be associated with each other in time-series. Meanwhile, when data augmentation is performed based on time-series data in which same motion stages are not appropriately associated with each other, realistic motion data cannot be generated.

In view of the problem described above, an object of the present disclosure is to provide an information processing apparatus, a method, and a program capable of accurately performing time-series association of data representing a set of motions per time step.

In an example aspect of the present disclosure, there is provided an information processing apparatus including:
an acquisition means configured to acquire a query that is data representing a set of motions per time step and a template to be compared with the query; and
an association identification means configured to repeatedly execute, in a case of identifying an association relationship between time steps of the query and time steps of the template, processing including: extracting unassociated time step(s) of the query and unassociated time step(s) of the template; and associating with each other a time step of the query and a time step of the template having the highest similarity between the extracted time step(s) of the query and the extracted time step(s) of the template.

In an example aspect of the present disclosure, there is provided a method including:
acquiring a query that is data representing a set of motions per time step and a template to be compared with the query; and
repeatedly executing, in a case of identifying an association relationship between time steps of the query and time steps of the template, processing including: extracting unassociated time step(s) of the query and unassociated time step(s) of the template; and associating with each other a time step of the query and a time step of the template having the highest similarity between the extracted time step(s) of the query and the extracted time step(s) of the template.

In an example aspect of the present disclosure, there is provided a program executed by a computer, the program causing the computer to:
acquire a query that is data representing a set of motions per time step and a template to be compared with the query; and
repeatedly execute, in a case of identifying an association relationship between time steps of the query and time steps of the template, processing including: extracting unassociated time step(s) of the query and unassociated time step(s) of the template; and associating with each other a time step of the query and a time step of the template having the highest similarity between the extracted time step(s) of the query and the extracted time step(s) of the template.

An example advantage according to the present disclosure is to accurately perform time-series association of data representing a set of motions per time step.

### BRIEF DESCRIPTION OF THE DRAWINGS

FIG. 1 illustrates a schematic configuration of a pseudo data generation system.

FIG. 2 illustrates a hardware configuration of a pseudo data generation device.

FIG. 3 is an example of functional blocks of the pseudo data generation device.

FIG. 4 illustrates an example of identifying the association relationship between a template and a query.

FIG. 5 illustrates an outline of association between a template having eight time steps and a query having six time steps.

FIG. 6 illustrates a similarity matrix representing the similarity between the template and the query for each time step.

FIG. 7 is a diagram illustrating an outline of the first to third processing of (processing X) and (processing Y) by a similarity matrix.

FIG. 8 is a diagram illustrating an outline of the fourth to sixth processing of the (processing X) and (processing Y) by a similarity matrix.

FIG. 9 illustrates an outline of associating the template and the query with each other in a comparative example in which time steps of the template and the query having the highest similarity are associated with each other.

FIG. 10 is an exemplary flowchart executed by the pseudo data generation device.

FIG. 11 is an example of a functional block of the pseudo data generation device having a configuration for adjusting the time series lengths of all the samples.

FIG. 12 is an example of a flowchart illustrating a processing flow of the pseudo data generation device having a configuration for adjusting the time series lengths of all the samples.

FIG. 13 illustrates a block diagram of the information processing apparatus.

FIG. 14 illustrates an example of the flowchart indicating the procedure of the process executed by the information processing apparatus.

### EXAMPLE EMBODIMENT

Hereinafter, example embodiments of an information processing apparatus, a method, and a storage medium will be described with reference to the drawings.

### First Example Embodiment

### (1) System Configuration

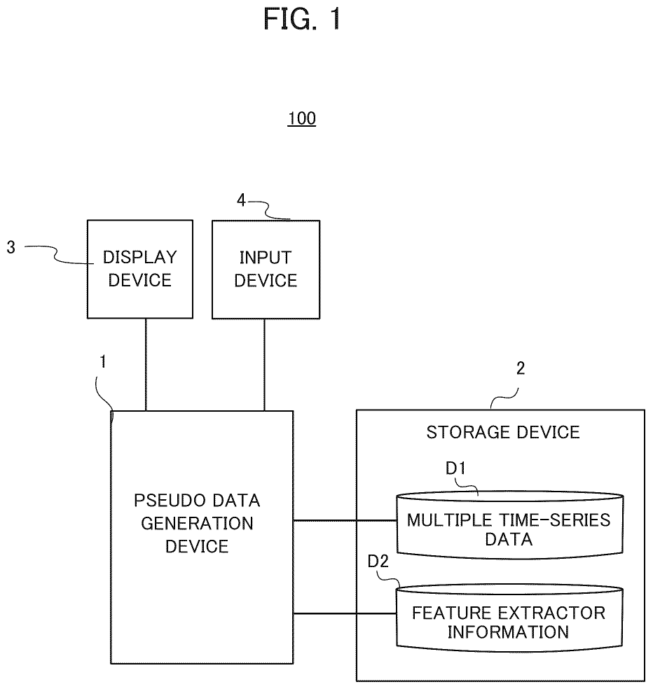

FIG. 1 illustrates a schematic configuration of a pseudo data generation system 100. The pseudo data generation system 100 generates pseudo data of time-series data for machine learning by data augmentation. The pseudo data generation system 100 mainly includes a pseudo data generation device 1, a storage device 2 storing multiple time-series data D1 and feature extractor information D2, a display device 3, and an input device 4.

The pseudo data generation device 1 performs data augmentation of the multiple time-series data D1 that is training data of a machine learning model, and generates pseudo data equating to intermediate data of any two pieces of time-series data included in the multiple time-series data D1. In this case, the pseudo data generation device 1 extracts features of the multiple time-series data D1 using a feature extractor constituted by the feature extractor information D2, and identifies an association relationship between pieces of time-series data in units of time steps based on a similarity of the extracted feature amounts. The pseudo data generation device 1 thus obtains consistency in time-series of any two pieces of time-series data and generates pseudo data, which is intermediate data of the two pieces of time-series data. The pseudo data generation device 1 may display information to be presented to a user of the pseudo data generation system 100 by the display device 3 and may receive a user's input (i.e., external input) with the input device 4.

The storage device 2 is a memory that stores various types of information necessary for processing the pseudo data generation device 1. The storage device 2 functionally includes the multiple time-series data D1 and the feature extractor information D2.

The multiple time-series data D1 includes “N” (N is an integer of equal to or more than 2) pieces of time-series data used for machine learning of a machine learning model. Each piece of time-series data is a set (i.e., a pair) of a sample that is data representing a motion of a subject person for each time step and a label representing correctness/incorrectness of a series of motions. For example, the multiple time-series data D1 is training data of a machine learning model for inferring correct/incorrect motion. In this case, the multiple time-series data D1 is training data for N records in which a sample for input to the machine learning model and a label indicating a correct answer to be output by the machine learning model are set as one record. The motion is, for example, a rehabilitation exercise, a sports exercise, or any other motion. Hereinafter, for convenience of description, description will be made on the assumption that a subject of motions is a person; however, the subject of the motions is not limited to a person and may be any moving body such as an animal or a robot.

Each sample may be, for example, a coordinate value representing a position of a joint (i.e., a skeleton) of a person for each time step, or may be a moving image (i.e., an RGB value for each pixel) captured for a moving person for each time step. The sample representing the position of the joint (i.e., the skeleton) for each time step is a tensor having a size of “the number of channels (the number of dimensions of coordinate space)×the number of joints×the number of time steps”, and the sample that is the moving image is a tensor having a size of “the number of channels (RGB)×longitudinal resolution×lateral resolution×the number of time steps”. Each label is, for example, a binary value representing correctness/incorrectness of motions. The samples may have different numbers of time steps. The multiple time-series data D1 may be treated as one piece of data in a tensor form having a size of “the number of samples (N)×the number of channels×the number of joints×the number of time steps” or “the number of samples (N)×the number of channels×the longitudinal resolution×the lateral resolution×the number of time steps”.

The feature extractor information D2 is information necessary for constituting a feature extractor, which is a machine learning model for extracting a feature amount of the sample. The feature extractor information D2 includes, for example, a parameter regarding an architecture for constituting the feature extractor, a parameter obtained by machine learning, and the like. Specifically, when the feature extractor is a neural network, the feature extractor information D2 includes, for example, various parameters (including hyperparameters) such as a layer structure, a neuron structure of each layer, the number of filters and a filter size in each layer, and a weight of each element of each filter. The feature extractor extracts, for each time step, a feature vector of a predetermined number of dimensions from input samples, for example. When N samples are input, therefore, the feature extractor outputs a feature amount (i.e., a feature map) of (the number of samples (N)×the number of time steps×the number of dimensions of the feature vector). The feature amount (i.e., the feature map) in this case equates a tensor obtained by convolution.

The storage device 2 may be an external storage device such as a hard disk connected to or incorporated in the pseudo data generation device 1, or may be a storage medium such as a portable flash memory. The storage device 2 may be a server device that performs data communication with the pseudo data generation device 1. The storage device 2 may include a plurality of devices.

The display device 3 displays information based on control of the pseudo data generation device 1. Examples of the display device 3 include a display, a projector, and the like. Upon receiving a display signal supplied from the pseudo data generation device 1, the display device 3 displays information based on the received display signal.

The input device 4 is an interface that receives a user's input, which is an external input based on an operation of the user using the pseudo data generation system 100. Examples of the input device 4 include a touch panel, a button, a keyboard, a voice input device, and the like. The input device 4 supplies an input signal generated based on the user's input to the pseudo data generation device 1.

The configuration of the pseudo data generation system 100 illustrated in FIG. 1 is an example, and various changes may be made to the configuration. For example, the pseudo data generation device 1, the storage device 2, the display device 3, and the input device 4 may be integrally configured by any combination. The pseudo data generation system 100 may include a sound output device, such as a speaker. The pseudo data generation device 1 may include a plurality of devices. In this case, the plurality of devices included in the pseudo data generation device 1 exchange information necessary for executing processing allocated in advance among the plurality of devices.

### (2) Hardware Configuration

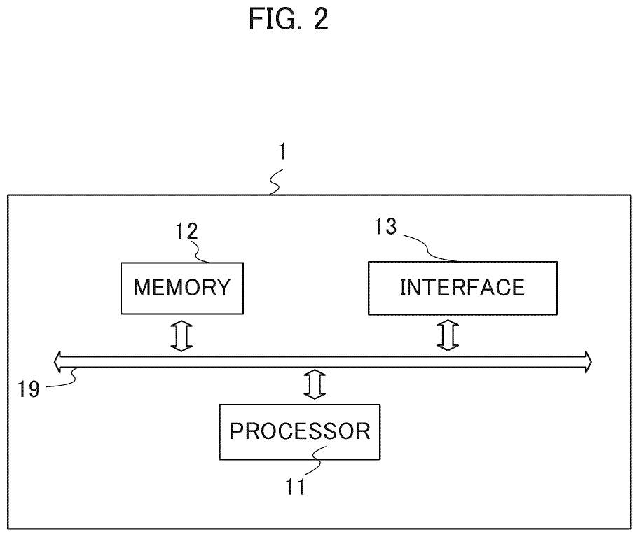

FIG. 2 illustrates a hardware configuration of the pseudo data generation device 1. The pseudo data generation device 1 includes, as hardware, a processor 11, a memory 12, and an interface 13. The processor 11, the memory 12, and the interface 13 are connected to one another via a data bus 19.

The processor 11 execute a program stored in the memory 12 to perform a predetermined process. The processor 11 is one or more processors such as a CPU (Central Processing Unit), a GPU (Graphics Processing Unit), and a TPU (Tensor Processing Unit). The processor 11 may be configured by plural processors. The processor 11 is an example of a computer.

The memory 12 is configured by volatile or non-volatile memories such as a RAM (Random Access Memory) and a ROM (Read Ony Memory). The memory 12 stores a program for the pseudo data generation device 1 to perform various processes. The memory 12 is used as a working memory, and temporarily stores information and the like acquired from the storage device 2. The memory 12 may function as the storage device 2. The storage device 2 may function as the memory 12 of the pseudo data generation device 1. The program executed by the pseudo data generation device 1 may be stored a storage medium other than the memory 12.

The interface 13 is one or more interfaces for electrically connecting the pseudo data generation device 1 and another device. These interfaces may include a wireless interface such as a network adapter for wirelessly transmitting and receiving data to and from the other device, or may include a hardware interface for connecting to the other device by a cable or the like.

A hardware configuration of the pseudo data generation device 1 is not limited to the configuration illustrated in FIG. 2. For example, the pseudo data generation device 1 may include at least one of the display device 3 or the input device 4. The pseudo data generation device 1 may be connected to or may incorporate a sound output device such as a speaker.

### (3) Outline of Pseudo Data Generation Processing

An outline of pseudo data generation processing executed by the pseudo data generation device 1 will be described. Schematically, the pseudo data generation device 1 defines the time-series data selected from the multiple time-series data D1 as a template and the time-series data other than the template as a query, and identifies an association relationship between the template and the query in units of time steps. In this case, the pseudo data generation device 1 sequentially selects, without overlapping, a pair of an unassociated time step of the template and time step of the query having the highest similarity in feature amount. The pseudo data generation device 1 thus appropriately obtains consistency in time series between the pieces of time-series data and suitably generates pseudo data, which is intermediate data between the pieces of time-series data having consistency in time series.

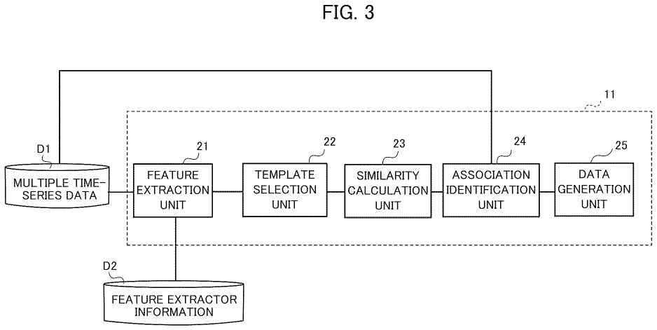

FIG. 3 is an example of functional blocks of the pseudo data generation device 1. As illustrated in FIG. 3, a processor 11 of the pseudo data generation device 1 functionally includes a feature extraction unit 21, a template selection unit 22, a similarity calculation unit 23, an association identification unit 24, and a data generation unit 25. While blocks that exchange data with each other are connected by a solid line in FIG. 3, a combination of the blocks that exchange data with each other is not limited thereto. The same applies to diagrams of other functional blocks described later.

The feature extraction unit 21 extracts the feature amount of each of the samples of the N pieces of time-series data extracted from the multiple time-series data D1. In this case, the feature extraction unit 21 acquires the feature amounts output from the feature extractor when the N samples are input to the feature extractor constituted with reference to the feature extractor information D2. In this case, the feature extraction unit 21 acquires the feature amount having a size of (the number of time steps ×feature amount dimension) for each of the N samples. The feature extraction unit 21 then supplies the feature amounts related to the N samples to the template selection unit 22, together with the related labels.

The template selection unit 22 selects a template from the N samples. The template selection unit 22, for example, randomly selects as a template a sample associated with a label indicating correct motion. The template selection unit 22 may select a template from the N samples by any method in addition to the method described above. For example, when acquiring an input for designating a template from the input device 4 or the like, the template selection unit 22 may select as a template a sample designated by the input. The template selection unit 22 supplies to the similarity calculation unit 23 a feature amount of the selected template and a feature amount of a sample other than the template (i.e., the query).

The similarity calculation unit 23 calculates the similarity in units of time steps between the feature amount of the template and the feature amount of the query selected from the samples other than the template. In this case, the similarity calculation unit 23 calculates a similarity matrix representing similarities of all combinations of the feature amounts of the template and the query in time step units. For example, between a template with the number of time steps “T1” and a query with the number of time steps “T2”, the similarity calculation unit 23 calculates a similarity matrix representing T1×T2 similarities equating to the total number of combinations of time steps. The similarity calculation unit 23 may use, as the similarity, cosine similarity, L1 distance, L2 distance, or any other index representing a degree of similarity between vectors. The similarity calculation unit 23 then calculates the similarity matrix described above for each of N-1 queries, and supplies the calculated similarity matrix to the association identification unit 24.

The association identification unit 24 identifies the association relationship between the template and each query in units of time steps, based on the similarity matrix calculated by the similarity calculation unit 23. In this case, the association identification unit 24 associates with each other, without overlapping, a pair of the unassociated time step of the template and time step of the query to be processed having the highest similarity in feature amount. Specifically, when identifying the association relationship between the template and the query to be processed in units of time steps, the association identification unit 24 repeats the following (processing X) and (processing Y) until association between all the time steps of the template is completed.

(Processing X) Extract an unassociated time step of the query to be processed and an unassociated time step of the template.

(Processing Y) Associate with each other a pair of an extracted unassociated time step of the query and unassociated time step of the template having the highest similarity in feature amount.

When there is a plurality of pairs having the highest similarity in feature amount in the (processing Y), the association identification unit 24 associates one pair selected at random with each other, for example.

When the time step of the query is shorter than the time step of the template and there is no more unassociated time step of the query in the (processing X), for example, the association identification unit 24 performs association by the following first or second method.

In the first method, the association identification unit 24 associates the time step of the query with each unassociated time step of the template having the highest similarity. In this case, the query has time steps associated with a plurality of the time steps of the template.

In the second method, the association identification unit 24 associates each unassociated time step of the template in such a way as to be consistent with an association of the time step adjacent to each unassociated time step of the template. For example, when a second time step of the template is not associated with any time step of the query, the time step of the query associated with a first time step or a third time step of the adjacent template is also associated with the second time step of the template.

The association identification unit 24 then restructures the query in such a way as to be consistent with the arrangement of the time steps of the template, based on an identified association relationship. In other words, the association identification unit 24 rearranges the time steps of the query related to these time steps in accordance with the arrangement of the time steps of the template.

For example, consider a case where a query having four time steps “Q1, Q2, Q3, and Q4” is associated with a template having five time steps of “T1, T2, T3, T4, and T5” in a manner of “(T1, Q1), (T2, Q1), (T3, Q3), (T4, Q2), and (T5, Q4)”. In this case, the association identification unit 24 rearranges the query in the order of “Q1”, “Q1”, “Q3”, “Q2”, and “Q4”. The restructured query thus has the same number of time steps as the template (i.e., five), and becomes consistent with the template in time series.

The association identification unit 24 then supplies to the data generation unit 25 each query restructured based on the relationship with the template and the template, together with the related label. Hereinafter, the restructured N-1 queries and templates are not distinguished from each other and are also referred to as “samples”. In this case, the association identification unit 24 supplies the N samples to the data generation unit 25, together with the related labels.

The data generation unit 25 generates pseudo data based on the set of samples and labels supplied from the association identification unit 24. In this case, the pseudo data is a set of pseudo sample and pseudo label related to the pseudo sample. For example, when the restructured N samples are expressed as X={x₁, x₂, . . . , x_{N}} and the related labels are expressed as N={y₁, y₂, . . . , y_{N}}, the data generation unit 25 randomly selects any two sets of samples and labels (xᵢ, yᵢ) and (xⱼ, yⱼ), and generates a pseudo sample obtained by linearly interpolating the selected samples xᵢ and xⱼ and a pseudo label obtained by linearly interpolating the labels yᵢ and yⱼ. In this case, when λ is a hyperparameter of 0 to 1 or a randomly sampled value, the pseudo sample and the pseudo label are calculated as follows.

λxᵢ+(1−λ)xⱼ

λyᵢ+(1−λ)yⱼ

The data generation unit 25 may generate the pseudo sample and the pseudo label using any algorithm that integrates two pieces of data, in addition to the linear interpolation described above.

The data generation unit 25 then generates a predetermined number of pieces of pseudo data by repeating any number of times selecting any two sets of samples and labels and generating the pseudo samples and the pseudo labels. Even when one sample includes an incorrect unit motion, the pseudo data generated in this manner is intermediate data generated based on a sample in which the same motion stages are appropriately associated with each other.

Here, each component of the feature extraction unit 21, the template selection unit 22, the similarity calculation unit 23, the association identification unit 24, and the data generation unit 25 can be implemented by, for example, the processor 11 executing a program. Each component may also be achieved by recording a necessary program in an optional nonvolatile storage medium and installing the program as necessary. At least a part of these components is not limited to be achieved by software by a program, and may be achieved by a combination of any of hardware, firmware, and software, or the like. At least a part of these components may be achieved using, for example, a user-programmable integrated circuit such as a field-programmable gate array (FPGA) or a microcontroller. In this case, a program including the above components may be achieved by using the integrated circuit. At least a part of the components may include an application specific standard produce (ASSP), an application specific integrated circuit (ASIC), or a quantum processor (quantum computer control chip). In this manner, the components may be achieved by various types of hardware. The same applies to other example embodiments described later. These components may also be achieved by, for example, cooperation of a plurality of computers by using a cloud computing technology or the like.

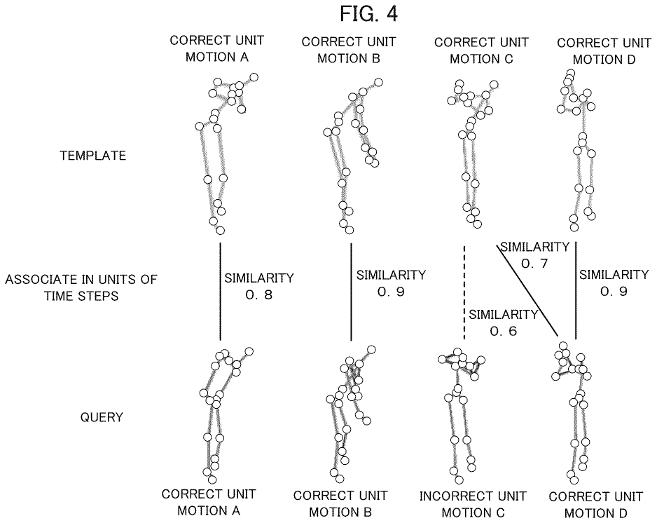

Here, an effect of executing the processing based on the functional block diagram illustrated in FIG. 3 will be supplementarily described with reference to FIG. 4.

FIG. 4 illustrates an example of identifying the association relationship between a template and a query. Here, each piece of time-series data is data representing a position of a joint of a person (equates to a circle in the drawing) who sequentially performs a unit motion A, a unit motion B, a unit motion C, and a unit motion D for each time step. Time-series data of a person who has correctly performed all of the unit motions A to D is selected as a template, and time-series data of a person who has correctly performed the unit motions A, B, and D and has incorrectly performed the unit motion C is selected as a query.

Here, if a pair of time steps of the template and query having the maximum similarity are associated with each other, since the unit motion C of the query is an incorrect motion, a similarity of the unit motion C between the template and the query is low although they are in the same motion stage. As a result, the similarity between the unit motion C of the template and the unit motion C of the query (i.e., 0.6) is lower than a similarity between the unit motion C of the template and the unit motion D of the query (i.e., 0.7). Therefore, when the time steps having the maximum similarity are associated with each other, the unit motion C of the template and the unit motion D of the query are associated with each other, associating different motion stages with each other. In this case, the query is restructured in the order of a “correct unit motion A”, a “correct unit motion B”, a “correct unit motion D”, and a “correct unit motion D”, excluding an “incorrect unit motion C”. As a result, the pseudo data generation device 1 cannot generate an intermediate motion between the correct motion and the incorrect motion for the unit motion C, and the time step of the incorrect motion cannot be used for generating pseudo data.

In consideration of the problem described above, the association identification unit 24 according to the present example embodiment sequentially selects, without overlapping, a pair of the unassociated time step of the template and time step of the query having the highest similarity in feature amount. In this case, since there remain time steps whose association relationships are uncertain and candidates for association are selected from the remainders, association is performed starting from a “pair of the time steps of the same motion stage of a correct unit motion” whose association relationship is certain. Then remains a “pair of the time steps of the same motion stage including an incorrect unit motion” whose association relationship is uncertain and other unassociated unit motions, and a “pair of the time steps of the same motion stage including the incorrect unit motion” are associated with each other. As described above, the pseudo data generation device 1 accurately limits the incorrect unit motion candidates, allowing accurate association of the time steps of the same motion stages. A specific example will be described later.

### (4) Specific Example

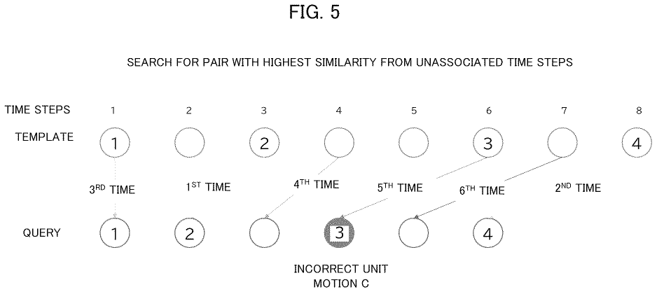

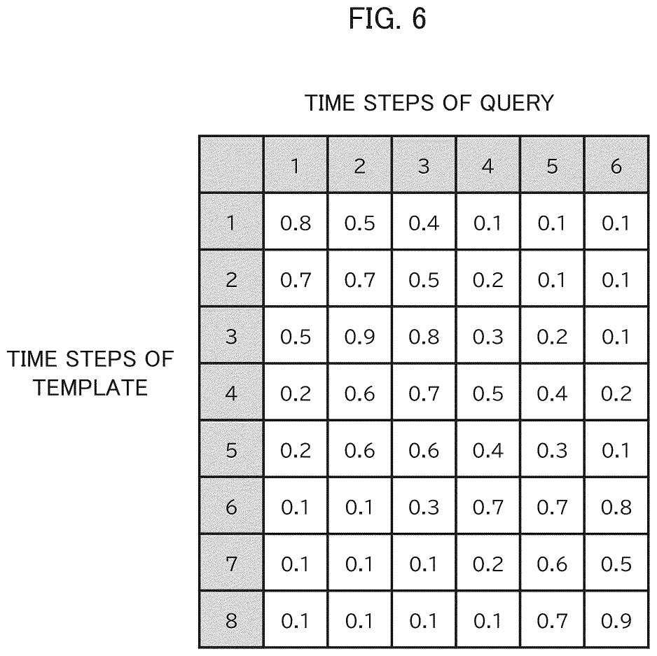

FIG. 5 illustrates an outline of association between a template having eight time steps and a query having six time steps. FIG. 6 illustrates a similarity matrix representing the similarity between the template and the query for each time step. Here, a sample is data for each time step including a unit motion 1 to a unit motion 4, and each time step of the template and the query is represented by a circle. In the circle representing the time step related to any one of the unit motions 1 to 4, a numeral representing that it relates to any one of the unit motions 1 to 4 (i.e., 1 to 4) is clearly indicated. Data of a fourth time step of the query represents the incorrect unit motion 3.

In the example of FIG. 5, the association identification unit 24 repeatedly executes the (processing X) and (processing Y) described above, based on the similarity matrix illustrated in FIG. 6. Here, the association identification unit 24 associates a third time step of the template with a second time step of the query by first (processing X) and (processing Y), and associates an eighth time step of the template with a sixth time step of the query by second (processing X) and (processing Y). The association identification unit 24 further associates a first time step of the template with a first time step of the query by third (processing X) and (processing Y), and associates a fourth time step of the template with a third time step of the query by fourth (processing X) and (processing Y). The association identification unit 24 further associates a sixth time step of the template with a fourth time step of the query by fifth (processing X) and (processing Y), and associates a seventh time step of the template with a fifth time step of the query by sixth (processing X) and (processing Y).

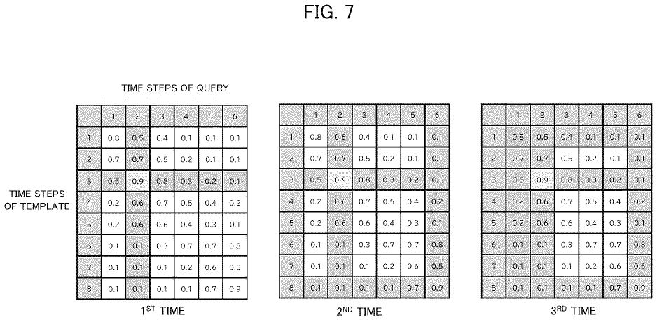

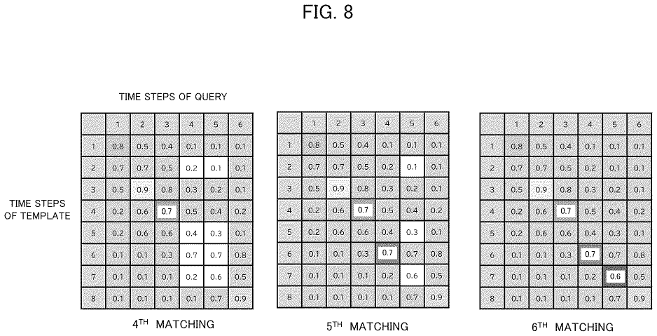

FIG. 7 is a diagram illustrating an outline of the first to third processing of (processing X) and (processing Y) by a similarity matrix, and FIG. 8 is a diagram illustrating an outline of the fourth to sixth processing of the (processing X) and (processing Y) by a similarity matrix. In FIGS. 7 and 8, elements related to the associated time steps are filled in.

In the first processing of (processing X) and (processing Y), a similarity between the third time step of the template and the second time step of the query is the maximum among all the elements of the similarity matrix, and thus the third time step of the template and the second time step of the query are associated with each other. The third time step of the template and the second time step of the query are thus excluded from candidates for association for the second and subsequent processing.

In the second processing of (processing X) and (processing Y), the eighth time step of the template and the sixth time step of the query are associated with each other, and the eighth time step of the template and the sixth time step of the query are excluded from the candidates for association for the third and subsequent processing. In the third processing of (processing X) and (processing Y), the first time step of the template and the first time step of the query are associated with each other, and the first time step of the template and the first time step of the query are excluded from the candidates for association for the fourth and subsequent processing.

In the fourth processing of (processing X) and (processing Y), the fourth time step of the template and the third time step of the query are associated with each other, and the fourth time step of the template and the third time step of the query are excluded from the candidates for association for the fifth and subsequent processing. In the fifth processing of (processing X) and (processing Y), the sixth time step of the template and the fourth time step of the query are associated with each other, and the sixth time step of the template and the fourth time step of the query are excluded from the candidates for association for the sixth and subsequent processing. The sixth (processing X) and (processing Y) associates the seventh time step of the template and the fifth time step of the query with each other.

Thereafter, since there is no unassociated time step of the query in the seventh (processing X), the association identification unit 24 associates the unassociated second and fifth time steps of the template with time steps of the query without performing the (processing X) and (processing Y). For example, the association identification unit 24 associates the first time step of the query, related to the first time step near the second time step of the template, with the second time steps of the template, and associates the third time step of the query, related to the fourth time step near the fifth time step of the template, with the fifth time steps of the template.

As described above, the association identification unit 24 is capable of appropriately associating the time steps of the same motion stage, including the fourth time step of the query that is an incorrect unit motion.

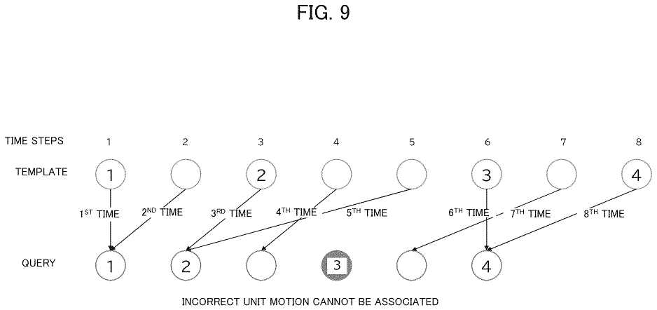

FIG. 9 illustrates an outline of associating the template and the query with each other in a comparative example in which time steps of the template and the query having the highest similarity are associated with each other. In the comparative example, when the similarity matrix illustrated in FIG. 6 is obtained, each time step of the template is associated with the time step of the query having the highest similarity based on the similarity matrix. As a result, the fourth time step of the query that is an incorrect unit motion is not associated with any time step of the template. In this case, no intermediate motion between an incorrect motion and a correct motion is generated and unit motion in different motion stages are linearly interpolated, generating pseudo data representing an unrealistic intermediate motion.

### (5) Processing Flow

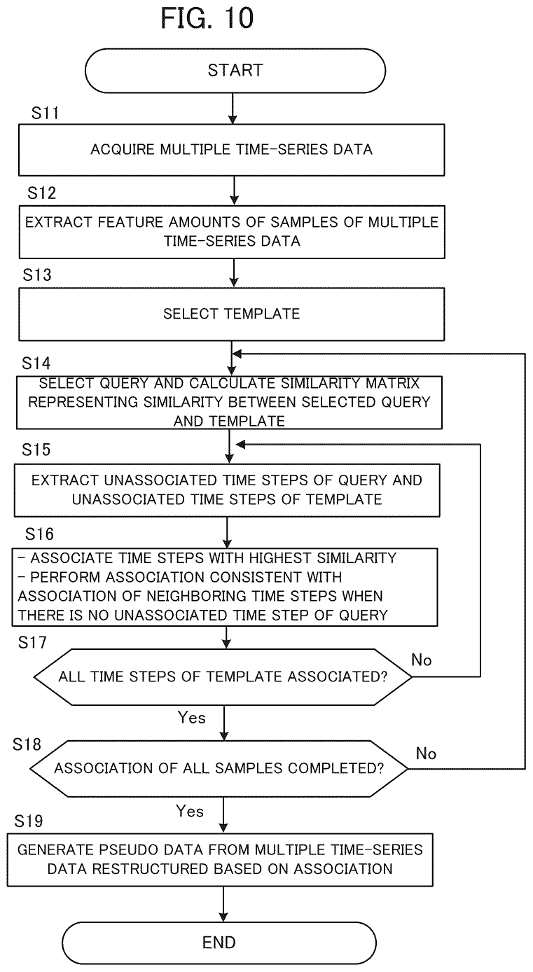

FIG. 10 is an exemplary flowchart executed by the pseudo data generation device 1.

The pseudo data generation device 1 acquires the multiple time-series data D1 (step S11). The pseudo data generation device 1 then extracts the feature amounts of the N samples of the multiple time-series data D1 (step S12). In this case, the pseudo data generation device 1 extracts from the multiple time-series data D1 the feature vector for each time step of the N samples using the feature extractor constituted by referring to the feature extractor information D2.

Next, the pseudo data generation device 1 selects a template (step S13). In this case, the pseudo data generation device 1 selects one template from the samples associated with a label indicating correct motion. The pseudo data generation device 1 then selects a query from the samples that are not the template, and calculates a similarity matrix representing the similarity between the selected query and template in units of time steps (step S14).

Next, the pseudo data generation device 1 extracts the unassociated time steps of the query and the unassociated time steps of the template (step S15). This processing equates the (processing X). The pseudo data generation device 1 then associates the time step of the query with the time step of the template having the highest similarity from the extracted unassociated time steps (step S16). This processing equates the (processing Y). When there is no unassociated time step of the query, the pseudo data generation device 1 also performs, for each unassociated time step of the template, association consistent with the association of adjacent time steps.

The pseudo data generation device 1 then determines whether all the time steps of the template are associated with the time steps of the query (step S17). When there is an unassociated time step of the template (step S17; No), the pseudo data generation device 1 returns the processing to step S15, and executes the processing of steps S15 and S16 again.

When it is determined that all the time steps of the template are associated with the time steps of the query (step S17; Yes), the pseudo data generation device 1 determines whether the association of all the samples is completed (step S18). That is, the pseudo data generation device 1 determines whether N-1 samples excluding the sample that is the template are selected as the query. When the association of all the samples is not completed (step S18; No), the pseudo data generation device 1 returns the processing to step S14, and the sample that is not selected as either the template or the query is selected as the query.

When the association of all the samples is completed (step S18; Yes), the pseudo data generation device 1 generates the pseudo data from the multiple time-series data restructured based on the association (step S19). In this case, the pseudo data generation device 1 rearranges the data such that the template and the time step are consistent with each other for each of the N-1 samples selected as the query. The pseudo data generation device 1 then generates pseudo data including a pseudo sample and a pseudo label, which is intermediate data of any two samples and related labels.

### (6) Application Example

According to the example embodiment described above, it is possible to perform data augmentation of training data for machine learning of a machine learning model applicable to a field of healthcare and the like and perform the machine learning of the machine learning model capable of outputting a highly accurate inference result. For example, it is possible to perform data augmentation of training data available for machine learning of a correct/incorrect motion determination model that outputs a correct/incorrect inference result of a rehabilitation exercise when video data of the rehabilitation exercise is input. By using the inference result output by the correct/incorrect motion determination model for which the machine learning has been performed with high accuracy using training data subject to data augmentation, it is possible to suitably support decision-making regarding rehabilitation instruction to a patient by medical workers, such as a doctor and a nurse. As described above, the present example embodiment is suitably applied to, for example, data augmentation of training data of a machine learning model that outputs an inference result available for decision-making of a medical worker in the healthcare field.

### Second Example Embodiment

A pseudo data generation device 1 in a second example embodiment executes the processing based on the first example embodiment after adjusting each sample in order to uniform time series lengths (i.e., the number of time steps) of all samples of the multiple time-series data D1. This arrangement enables the pseudo data generation device 1 according to the second example embodiment to obtain a same number of time steps of the template and the query to suitably associate the template and the query with each other.

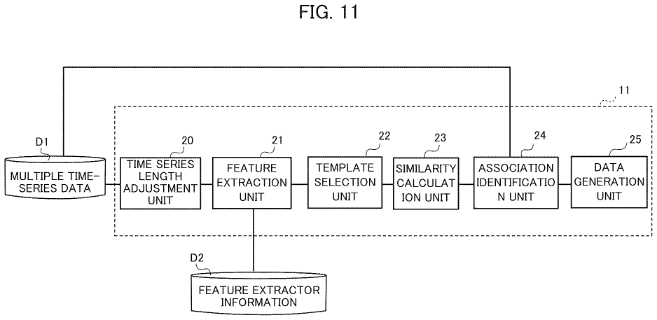

FIG. 11 is an example of a functional block of the pseudo data generation device 1 having a configuration for adjusting the time series lengths of all the samples. In this case, a processor 11 of the pseudo data generation device 1 includes the feature extraction unit 21, the template selection unit 22, the similarity calculation unit 23, the association identification unit 24, and the data generation unit 25 based on the first example embodiment, and a time series length adjustment unit 20 provided at a preceding stage of the feature extraction unit 21.

After acquiring the multiple time-series data D1, the time series length adjustment unit 20 acquires the number of time steps of the sample having the maximum number of time steps (i.e., the maximum time series length) from the N samples of the multiple time-series data D1 (it is also referred to as “the maximum number of time steps”). The time series length adjustment unit 20 then interpolates (for example, linearly interpolates) each sample in a time axis direction such that all the N samples have the maximum number of time steps. For example, when the sample of the multiple time-series data D1 is data in a tensor format of (the number of channels ×the number of joints×the number of time steps), the sample is converted into data in a tensor format of (the number of channels×the number of joints×the maximum number of time steps). As a result, the N samples output by the time series length adjustment unit 20 are represented by data in a tensor format of (the number of samples×the number of channels ×the number of joints ×the maximum number of time steps). The time series length adjustment unit 20 supplies to the feature extraction unit 21 the N samples whose time series lengths have been adjusted and related labels. Instead of setting the number of time steps of the N samples to the maximum number of time steps, the time series length adjustment unit 20 may adjust the number of time steps of the N samples to a predetermined number of time steps.

The feature extraction unit 21 extracts feature amounts of the N samples whose time series lengths have been adjusted. The template selection unit 22, the similarity calculation unit 23, the association identification unit 24, and the data generation unit 25 perform the same processing as that of the first example embodiment to generate pseudo data, based on the feature amounts generated by the feature extraction unit 21.

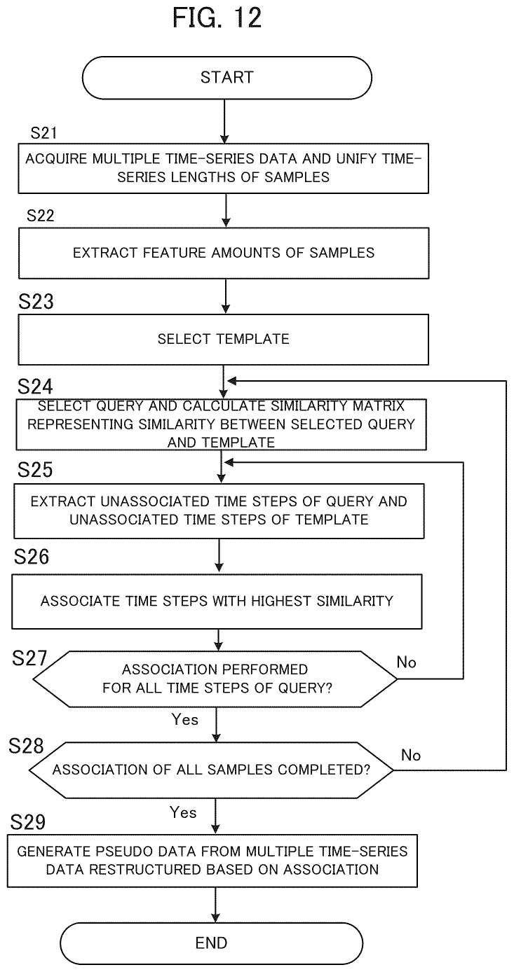

FIG. 12 is an example of a flowchart illustrating a processing flow of the pseudo data generation device 1 having a configuration for adjusting the time series lengths of all the samples.

First, the pseudo data generation device 1 acquires the multiple time-series data D1, and unifies the time series lengths of the N samples included in the multiple time-series data D1 (step S21). In this case, the pseudo data generation device 1 converts the N samples in such a way that the maximum number of time steps is obtained. The pseudo data generation device 1 then extracts the feature amounts of the converted N samples (step S22).

Next, the pseudo data generation device 1 selects a template (step S23). The pseudo data generation device 1 then selects a query from the samples that are not the template, and calculates a similarity matrix representing the similarity between the selected query and template in units of time steps (step S24). Next, the pseudo data generation device 1 extracts the unassociated time steps of the query and the unassociated time steps of the template (step S25). The pseudo data generation device 1 then associates the time step of the query with the time step of the template having the highest similarity from the extracted unassociated time steps (step S26).

The pseudo data generation device 1 then determines whether all the time steps of the query are associated with the time steps of the template (step S27). When there is an unassociated time step of the template (step S27; No), the pseudo data generation device 1 returns the processing to step S25, and executes the processing of steps S25 and S26 again.

When it is determined that all the time steps of the template are associated with the time steps of the query (step S27; Yes), the pseudo data generation device 1 determines whether the association of all the samples is completed (step S28). When the association of all the samples is not completed (step S28; No), the pseudo data generation device 1 returns the processing to step S14, and the sample that is not selected as either the template or the query is selected as the query.

When the association of all the samples is completed (step S28; Yes), the pseudo data generation device 1 generates the pseudo data from the multiple time-series data restructured based on the association (step S29).

As described above, the pseudo data generation device 1 according to the second example embodiment is capable of reliably associating the time steps of the same motion stages with each other even when an incorrect unit motion is included.

### Third Example Embodiment

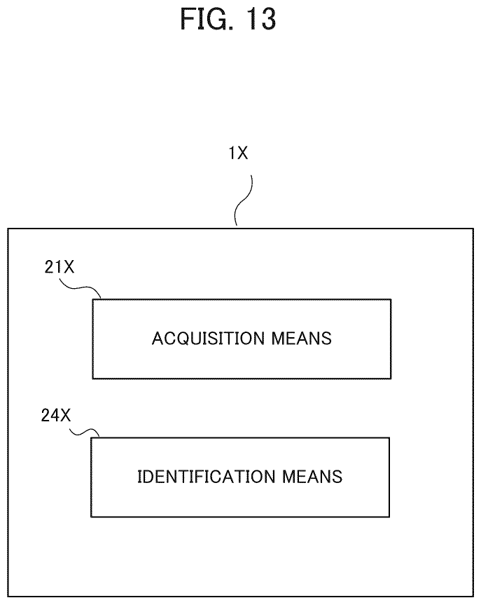

FIG. 13 illustrates a block diagram of the information processing apparatus 1X. The information processing apparatus 1X includes an acquisition means 21X and an identification means 24X. Examples of the information processing apparatus 1X include the pseudo data generation device 1 according to the first example embodiment or the second example embodiment.

The acquisition means 21X is configured to acquire a query that is data representing a set of motions per time step and a template to be compared with the query. Examples of the acquisition means 21X include the feature extraction unit 21 according to the first example embodiment or the time series length adjustment unit 20 according to the second example embodiment.

The association identification means 24X is configured to repeatedly execute, in a case of identifying an association relationship between time steps of the query and time steps of the template, processing including: extracting unassociated time step(s) of the query and unassociated time step(s) of the template; and associating with each other a time step of the query and a time step of the template having the highest similarity between the extracted time step(s) of the query and the extracted time step(s) of the template. Examples of the identification means 24X include the association identification unit 24 according to the first example embodiment or the second example embodiment.

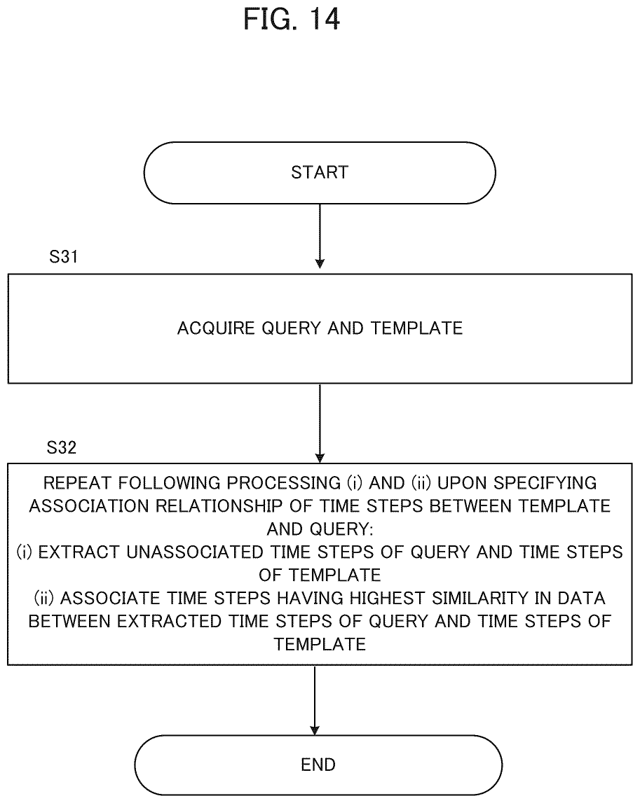

FIG. 14 illustrates an example of the flowchart indicating the procedure of the process executed by the information processing apparatus 1X. First, the acquisition means 21X acquires a query that is data representing a set of motions per time step and a template to be compared with the query (step S31). Next, the association identification means 24X repeatedly executes, in a case of identifying an association relationship between time steps of the query and time steps of the template, processing including: extracting unassociated time step(s) of the query and unassociated time step(s) of the template; and associating with each other a time step of the query and a time step of the template having the highest similarity between the extracted time step(s) of the query and the extracted time step(s) of the template (step S32).

The information processing apparatus 1X according to the third example embodiment can accurately associate the query with the template in units of time steps to match the action stages of them.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

In addition, some or all of the above-described example embodiments may also be described as following Supplementary Notes, but are not limited to the following. Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### [Supplementary Note 1]

An information processing apparatus comprising:
an acquisition means configured to acquire a query that is data representing a set of motions per time step and a template to be compared with the query; and
an association identification means configured to repeatedly execute, in a case of identifying an association relationship between time steps of the query and time steps of the template, processing including: extracting unassociated time step(s) of the query and unassociated time step(s) of the template; and associating with each other a time step of the query and a time step of the template having the highest similarity between the extracted time step(s) of the query and the extracted time step(s) of the template.

### [Supplementary Note 2]

The information processing apparatus according to Supplementary Note 1, further comprising
a generation means configured to generate pseudo data representing the motion in a pseudo manner, based on the query, which is restructured to be consistent with the time steps of the template based on the association relationship, and the template.

### [Supplementary Note 3]

The information processing apparatus according to Supplementary Note 1, further comprising:
a time-series length adjustment means configured to adjust time lengths of samples each representing a set of motions per time step so that the samples have an equal number of time steps and
a selection means configured to select the query and the template from the samples after the time lengths are adjusted.
   [supplementary Note 4]

The information processing apparatus according to Supplementary Note 3, wherein
a label indicating correctness/incorrectness of the motions is associated with each of the samples, and the selection means is configured to select, as the template, a sample related to the label indicating the correctness of the motions.

### [Supplementary Note 5]

The information processing apparatus according to Supplementary Note 1, further comprising
a feature extraction means configured to extract feature amounts of the query and the template for each of the time steps, and
wherein the association identification means is configured to identify the association relationship, based on the similarity calculated based on the feature amounts.

### [Supplementary Note 6]

The information processing apparatus according to Supplementary Note 1, further comprising
a similarity calculation means configured to calculate a similarity matrix representing the similarity of all combinations of the time step of the query and the time step of the template,
wherein the association identification means is configured to identify the association relationship based on the similarity matrix.

### [Supplementary Note 7]

The information processing apparatus according to Supplementary Note 2, wherein
the query and the template are training data used for machine learning of an artificial intelligence model that outputs information used to support decision making, and
the pseudo data is the training data generated by data augmentation.

### [Supplementary Note 8]

The information processing apparatus according to Supplementary Note 2,
wherein the generation means is configured to generate the pseudo data based on any pair selected from the restructured one or more queries and the template.

### [Supplementary Note 9]

A method executed by a computer, comprising:
acquiring a query that is data representing a set of motions per time step and a template to be compared with the query; and
repeatedly executing, in a case of identifying an association relationship between time steps of the query and time steps of the template, processing including: extracting unassociated time step(s) of the query and unassociated time step(s) of the template; and associating with each other a time step of the query and a time step of the template having the highest similarity between the extracted time step(s) of the query and the extracted time step(s) of the template.

### [Supplementary Note 10]

A program executed by a computer, the program causing the computer to:
acquire a query that is data representing a set of motions per time step and a template to be compared with the query; and
repeatedly execute, in a case of identifying an association relationship between time steps of the query and time steps of the template, processing including: extracting unassociated time step(s) of the query and unassociated time step(s) of the template; and associating with each other a time step of the query and a time step of the template having the highest similarity between the extracted time step(s) of the query and the extracted time step(s) of the template.

### [Supplementary Note 11]

A non-transitory computer readable storage medium storing the program according to Supplementary Note 10.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1 Pseudo data generation device
1X Information processing apparatus
2 Storage device
3 Display device
4 Input device
11 Processor
12 Memory
13 Interface
100 Pseudo data generation system

1. An information processing apparatus comprising:
at least one memory configured to store instructions, and
at least one processor configured to execute the instructions to:
acquire a query that is data representing a set of motions per time step and a template to be compared with the query; and
repeatedly execute, in a case of identifying an association relationship between time steps of the query and time steps of the template, processing including: extracting unassociated time step(s) of the query and unassociated time step(s) of the template; and associating with each other a time step of the query and a time step of the template having the highest similarity between the extracted time step(s) of the query and the extracted time step(s) of the template.

2. The information processing apparatus according to claim 1,
wherein the at least one processor is further configured to execute the instructions to generate pseudo data representing the motion in a pseudo manner, based on the query, which is restructured to be consistent with the time steps of the template based on the association relationship, and the template.

3. The information processing apparatus according to claim 1,
wherein the at least one processor is further configured to execute the instructions to
adjust time lengths of samples each representing a set of motions per time step so that the samples have an equal number of time steps and
select the query and the template from the samples after the time lengths are adjusted.

4. The information processing apparatus according to claim 3, wherein
a label indicating correctness/incorrectness of the motions is associated with each of the samples, and
the at least one processor is further configured to execute the instructions to select, as the template, a sample related to the label indicating the correctness of the motions.

5. The information processing apparatus according to claim 1,
wherein the at least one processor is further configured to execute the instructions to
extract feature amounts of the query and the template for each of the time steps, and
identify the association relationship, based on the similarity calculated based on the feature amounts.

6. The information processing apparatus according to claim 1,
wherein the at least one processor is further configured to execute the instructions to
calculate a similarity matrix representing the similarity of all combinations of the time step of the query and the time step of the template,
identify the association relationship based on the similarity matrix.

7. The information processing apparatus according to claim 2, wherein
the query and the template are training data used for machine learning of an artificial intelligence model that outputs information used to support decision making, and
the pseudo data is the training data generated by data augmentation.

8. The information processing apparatus according to claim 2,
wherein the at least one processor is further configured to execute the instructions to
generate the pseudo data based on any pair selected from the restructured one or more queries and the template.

9. A method executed by a computer, comprising:
acquiring a query that is data representing a set of motions per time step and a template to be compared with the query; and
repeatedly executing, in a case of identifying an association relationship between time steps of the query and time steps of the template, processing including: extracting unassociated time step(s) of the query and unassociated time step(s) of the template; and
associating with each other a time step of the query and a time step of the template having the highest similarity between the extracted time step(s) of the query and the extracted time step(s) of the template.

10. A non-transitory computer readable storage medium storing a program executed by a computer, the program causing the computer to:
acquire a query that is data representing a set of motions per time step and a template to be compared with the query; and
repeatedly execute, in a case of identifying an association relationship between time steps of the query and time steps of the template, processing including: extracting unassociated time step(s) of the query and unassociated time step(s) of the template; and associating with each other a time step of the query and a time step of the template having the highest similarity between the extracted time step(s) of the query and the extracted time step(s) of the template.
